(19) United States
(12) Patent Application Publication
(10) Pub. No.: US 2024/0278799 A1
(43) Pub. Date: Aug. 22, 2024

(54) AUTONOMOUS VEHICLE DATA SEARCHING AND AUDITING SYSTEM

(71) Applicant: Siemens AKtiengesellschaft, München (DE)

(72) Inventors: Saadhana B Venkataraman, Chennai, Tamil Nadu (IN); Vijaya Sarathi Indla, Bangalore, Karnataka (IN); Bony Mathew, Perumbavoor, Kerala (IN); Saikat Mukherjee, Bangalore, Karnataka (IN); Ram Padhy, Ganjam, Odisha (IN); Sagar Pathrudkar, Pune, Maharashtra (IN); Bristi Singh, Bangalore, Karnataka (IN)

(21) Appl. No.: 18/571,786

(22) PCT Filed: Jun. 24, 2021
(86) PCT No.: PCT/EP2021/067294

§ 371 Date: Dec. 19, 2023

(51) Int. Cl. B60W 50/14; B60W 60/00; G06F 16/245; G06F 16/25

(52) U.S. Cl. CPC B60W 50/14; B60W 60/00; G06F 16/245; G06F 16/258; B60W 2520/10; B60W 2520/105; B60W 2520/14; B60W 2556/50

(57) ABSTRACT

An autonomous vehicle data searching and auditing system, is provided. The AVDSAS includes a scenario database storing therein autonomous vehicle data associated with AV(s). The AVDSAS has a scenario extraction module that is in operable communication with the scenario database. The scenario extraction module extracts scenario data from the AV data and stores the scenario data into the scenario database, wherein the scenario data includes AV parameter(s), object(s), and operational design domain element(s) associated with the AV(s). The AV data stored in the scenario database is searchable based on a query. The scenario extraction model generates scenario(s) using the scenario data from the scenario database based on the query.

### CROSS-REFERENCE TO RELATED APPLICATIONS

This application claims priority to PCT Application No. PCT/EP2021/067294, having a filing date of Jun. 24, 2021, the entire contents all of which are hereby incorporated by reference.

### FIELD OF TECHNOLOGY

The following relates to autonomous vehicle driving in general and more particularly, to a system and method for identifying and auditing scenarios associated with autonomous vehicle driving.

### BACKGROUND

Autonomous vehicles (AVs) as public and private transportation are fast becoming a reality. However, the safety assessment of AVs still remains a concern. Even though businesses working in the Automated Driving System (ADS) domain have access to large scale data from hours of test driving in real world scenarios, identifying safety critical scenarios based on quantifiable safety metrics and eventually creating a way to audit the safe/unsafe scenarios in each trip made by the AV is still largely lacking.

Moreover, an AV typically has many sensors mounted thereon such as a camera, a LiDAR, a RADAR, an IMU, etc., for capturing data pertaining to the environment around the AV, using which the AV can guide itself more accurately. According to various surveys, these sensors generate data as huge as 30 GB/hour for a single AV, thereby creating a challenge of handling data at a very large scale. For researchers working in the field of AVs, this data poses an opportunity to improve their methods and algorithms particularly for certain real-life events that tend to cause problems for the AVs. However, finding such events or scenarios from such a huge dataset is a humongous task. Conventional methods known for identifying scenarios of interest from huge datasets of AVs include manually scavenging through each data file and annotating events or processing each data file through algorithms which annotate certain events. These methods are largely time and effort intensive. Although, the method of processing each data file via annotation algorithms requires comparatively less effort than manual annotation method, this method still is time consuming especially when someone wants to know whether two or more events happened in the same data file.

Thus, the problem of identifying scenarios of interest from AV data at large scale is time and effort intensive and therefore, overwhelming for AV data researchers whose efforts should ideally be more focused on developing algorithms for managing such scenarios rather than actually spending time, energy, and money in identifying such scenarios from the huge datasets.

### SUMMARY

An aspect relates to a system and a method for identifying scenarios associated with an autonomous vehicle (AV) in a time, effort and a cost-effective way.

As used herein, “autonomous vehicle data”, hereinafter referred to as AV data, refers to data pertaining to one or more AVs and to the ambient surroundings of the AVs, that is captured in real-time, near real-time or as historical data. The AV data comprises data recorded by sensor(s) mountable on the AVs. As used herein, the term “sensor” refers to camera(s) mountable on the AV for recording images and/or videos of the surroundings thereof, laser-based sensors such as LiDARs and LADARs, radio-based sensors such as RADARs, Inertial Measurement Unit (IMU) sensors, ambient condition monitoring sensors sensing temperature, humidity, pressure, particulate matter, etc., surrounding the AV. A data acquisition module of the AVDSAS disclosed herein receives the AV data from the sensor(s). The data acquisition module verifies whether the AV data is in an automotive industry standard format such as ROSbag or MDF. The data acquisition module converts the AV data into an automotive industry standard format when the AV data is not in the automotive industry standard format.

The AVDSAS stores the AV data into a scenario database. The scenario database, according to an embodiment of the present disclosure, is a location on a file system directly accessible by the AVDSAS. According to another embodiment, the scenario database is deployed in a cloud computing environment accessible by the AVDSAS via a communication network. As used herein, “cloud computing environment” refers to a processing environment comprising configurable computing physical and logical resources, for example, networks, servers, storage, applications, services, etc., and data distributed over the cloud platform. The cloud computing environment provides on-demand network access to a shared pool of the configurable computing physical and logical resources. According to an embodiment of the present disclosure, one or more components of the AVDSAS disclosed herein are deployed in the cloud-computing environment and are accessible to a user of the AVDSAS via APIs. According to another embodiment, the AVDSAS is completely deployed in the cloud computing environment and is accessible to the user of the AVDSAS via APIs. According to yet another embodiment, one or more components of the AVDSAS are downloadable on a user device of a user of the AVDSAS.

According to yet another embodiment, the AVDSAS is configured as an edge device capable of communicating with the scenario database via a communication network. According to this embodiment, the AVDSAS comprises a processor, a memory unit, a network interface, and/or an input/output unit to function as an edge device. For example, in order to function as an edge device, the aforementioned hardware components of the AVDSAS are deployed on the AV or at a site where a fleet of AVs is typically parked, the hardware components being in operable communication with the sensors either via a wired communication network or via a wireless communication network. Moreover, according to this embodiment, there may exist more than one AVDSASs as edge devices deployed on several AVs wherein each of the AVDSASs are capable of communicating with one another for managing the AV data, searching, and auditing the AV data in a fleet of AVs.

The AVDSAS stores the AV data into the scenario database of the AVDSAS configured to store therein the AV data associated with the AV(s). The AVDSAS stores the AV data into the scenario database in the form of static data and dynamic data. The static data comprises, for example, data associated with the sensors such as number of cameras mounted on the AV, focal length of each camera, field of view of each camera, positional co-ordinates of each camera, shutter speed of each camera, network or road geometry, that is, orientation of the road whether it curves or it is a straight road, length of a road visible in the field of view of the camera, etc. The dynamic data comprises, for example, data subject to change on a regular basis such as ambient conditions pertaining to weather, data recorded by the sensors at various time instances pertaining to the AV during its trip, and/or data received from external sources, that is, from sensors mounted elsewhere including other AVs.

The AV data stored in the scenario database is searchable based on a query. As used herein, the term “query.” refers to a string entered by a user using the AVDSAS for purposes of searching, auditing and/or analyzing the AV data. The query comprises, for example, a string of words conjoined via operators. The query mainly includes a query type and query criteria. The query type comprises, for example, a search-based query, an audit-based query, and/or a performance report-based query. The query criteria comprise, for example, specific parameters associated with scenario(s), operation design domain element(s), performance reports, etc. As an example, a query may be provided as below:

Search AND Scenario(school crossing AND velocity=60 km/s)

Where “Search” is the query type and “Scenario(school crossing AND velocity=60 km/s)” are the query criteria.

As used herein, the term “scenario” refers to a series of actions pertaining to the AV and occurring over a period, that is, through a single trip of the AV or through a predetermined time duration for which the AV was operating. The scenarios include, for example, an overtaking scenario, an unprecedented turning scenario, a pedestrian crossing scenario, a sudden deceleration scenario, etc.

As used herein, “operational design domain elements” hereinafter referred to as ODD elements, refer to constraint(s) associated with a domain in which an AV is configured to operate, that is, the scope and limits of driving for an AV. The ODD elements comprise, for example, environmental constraints such as clear weather, geographical constraints such as speed limit zone, and time-of-day constraints such as night driving, and/or presence or absence of certain traffic or roadway characteristics such as congestion or sharp curve.

The AVDSAS disclosed herein comprises a scenario extraction module in operable communication with the scenario database. The scenario extraction module extracts scenario data from the AV data and stores the scenario data into the scenario database. As used herein, “scenario data” refers to data required to construct the aforementioned scenario(s). The scenario data comprises, for example, autonomous vehicle (AV) parameter(s) including but not limited to an acceleration, a yaw, a velocity, and global positioning system coordinates of the AV(s), and object(s) including but not limited to stationary and moving objects such as trees, pedestrians, other AVs, other vehicles, etc.

For extracting the scenario data, the scenario extraction module, extracts metadata from the AV data, for example, a size of the AV data file such as the size of the ROSBag(s), a start time and/or an end time of the trip made by the AV to which the AV data corresponds, etc. The scenario extraction module also stores the metadata into the scenario database. The scenario extraction module determines the aforementioned AV parameter(s) from the AV data. The scenario extraction module extracts object(s) from the AV data. For extracting objects, the scenario extraction module extracts image frames at a pre-defined time interval from the AV data, for example, 1 second time interval and determines object(s) from each of the image frames by applying one or more object detection algorithms on the image frames. The AVDSAS enables its users to upload object annotation and detection algorithm(s) of their choice based on the type of AV data being handled.

According to an embodiment of the present disclosure, an ODD module of the AVDSAS disclosed herein obtains the ODD element(s) from the AV data. The ODD elements are extracted using one or more ODD extraction algorithms and stored in the scenario database or an ODD database located within or outside the scenario database. The ODD module obtains the ODD element(s) from the scenario database based on the query, that is, the query parameters.

The scenario extraction module generates one or more scenarios using the scenario data from the scenario database based on the query. The scenario extraction module generates the scenario(s) using the AV parameters, the objects, and the AV data stored in the scenario database based on the aforementioned query parameters. According to an embodiment of the present disclosure, the scenario extraction module groups the scenario(s) generated, using the ODD element(s) stored in the scenario database.

The AVDSAS disclosed herein comprises an audit module that determines from the scenario database, a safe scenario, an unsafe scenario, and a critical scenario, based on predefined audit parameters and the query. As used herein, “predefined audit parameters” refer to local legal laws where the AV is plying. The scenario extraction module constructs the scenarios, and the audit module determines whether the scenarios are safe, unsafe and/or critical. The audit module generates reports based on performance of the AVs for a given duration such as a single trip or a collective performance over several trips. The performance may also be gauged for a fleet of AVs.

Also disclosed herein, is a method for managing AV data. In embodiments, the method employs aforementioned AVDSAS. In embodiments, the method comprises obtaining AV data from the sensor(s) mountable on AV(s), extracting, from the AV data, scenario data associated with the AV(s), the scenario data comprising the AV parameter(s) and the object(s) associated with the AV(s), and storing the scenario data into the scenario database. In embodiments, the method after receiving the AV data verifies whether the AV data is in an automotive industry standard format and converts the AV data into an automotive industry standard format when the AV data is not in the automotive industry standard format. In embodiments, the method extracts the scenario data by obtaining from the AV data, the AV parameter(s), and the object(s) associated with the AV. In embodiments, the method, according to an embodiment, obtains the ODD element(s) from the AV data.

In embodiments, the method and the AVDSAS disclosed herein, over a period of time, generate a scenario database including therewithin the scenario data pertaining to various AVs that a user can easily search through. Such a search platform not only helps the users to query the raw and annotated sensor data of AVs, but also query the data of other objects on the road like cars, pedestrians, cyclists, etc., by simply processing the data through AVDSAS that can track and extract scenarios for other road users. Also, since AVDSAS can process any dataset, AVDSAS can be used for processing any open public datasets like KITTI or custom-made datasets, thereby making it dataset agnostic and scalable in nature.

Also disclosed herein, is a method for searching and auditing AV data. In embodiments, the method employs aforementioned AVDSAS. In embodiments, the method comprises obtaining query parameters from the query for searching and auditing the AV data, generating one or more scenarios based on the query parameters, and rendering the scenario(s) on a graphical user interface (GUI) of the AVDSAS. In embodiments, the method generates the scenario(s) by constructing, based on the query parameters of the query, a scenario using the AV parameter(s), the object(s), and the AV data stored in the scenario database. According to an embodiment, the method, based on the query parameters, obtains ODD element(s) from the scenario database and renders the ODD element(s) on the GUI. According to yet another embodiment, the method determines from the scenario database, based on the query parameters and predefined audit parameters, a safe scenario, an unsafe scenario, and/or a critical scenario. According to this embodiment, the method renders the safe scenario, the unsafe scenario, and/or the critical scenario on the GUI. According to yet another embodiment, the method generates performance report(s) based on performance of the AVs. In embodiments, the method uses the scenario data for generating such reports, for example, whether the AV encountered any unsafe and/or critical scenarios during its trip.

Also disclosed herein, is a computer program product (non-transitory computer readable storage medium having instructions, which when executed by a processor, perform actions) comprising machine-readable instructions stored therein, which when executed by at least one server/processor perform the aforementioned methods for managing AV data and for searching and auditing the AV data.

The above summary is merely intended to give a short overview over some features of some embodiments and implementations and is not to be construed as limiting. Other embodiments may comprise other features than the ones explained above.

### BRIEF DESCRIPTION OF THE DRAWINGS

Some of the embodiments will be described in detail, with references to the following Figures, wherein like designations denote like members, wherein:

FIG. 1A is a schematic representation of an autonomous vehicle data searching and auditing system (AVDSAS), according to an embodiment of the present disclosure:

FIG. 1B is a schematic representation of a scenario extraction module of the AVDSAS shown in FIG. 1A, according to an embodiment of the present disclosure;

FIG. 1C is a schematic representation of an operational design domain (ODD) module of the AVDSAS shown in FIG. 1A, according to an embodiment of the present disclosure:

FIG. 1D is a schematic representation of an audit module of the AVDSAS shown in FIG. 1A, according to an embodiment of the present disclosure;

FIG. 2 is a block diagram illustrating an architecture of a computer system employed by the AVDSAS shown in FIG. 1A, according to an embodiment of the present disclosure:

FIG. 3 is a process flowchart representing a method for managing autonomous vehicle data, according to an embodiment of the present disclosure; and

FIG. 4 is a process flowchart representing a method for searching and analyzing autonomous vehicle data, according to an embodiment of the present disclosure.

### DETAILED DESCRIPTION

In the following, embodiments of the disclosure will be described in detail with reference to the accompanying drawings. It is to be understood that the following description of embodiments is not to be taken in a limiting sense.

The drawings are to be regarded as being schematic representations and elements illustrated in the drawings, which are not necessarily shown to scale. Rather, the various elements are represented such that their function and general purpose become apparent to a person skilled in the conventional art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

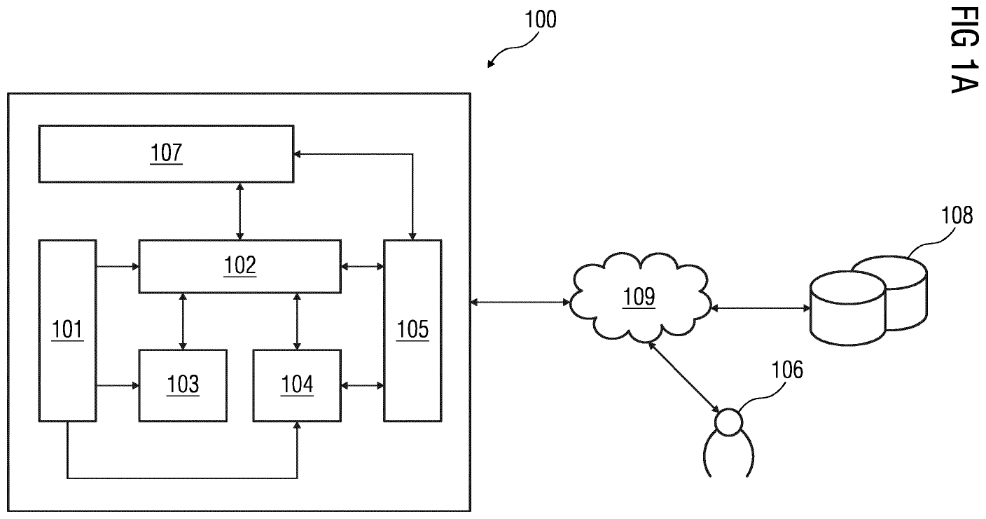

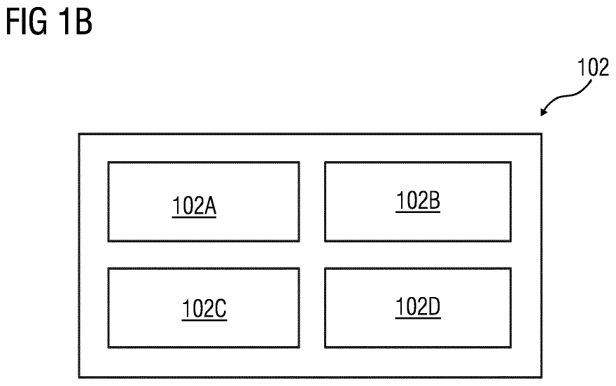

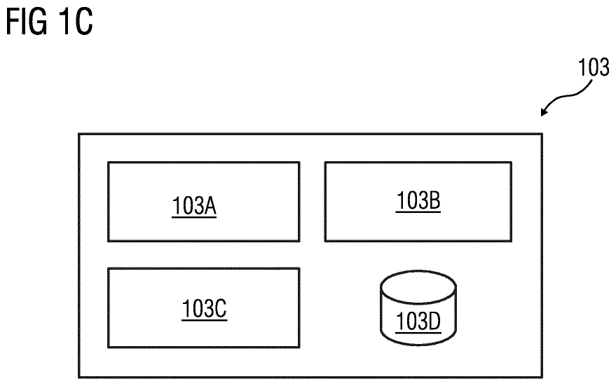

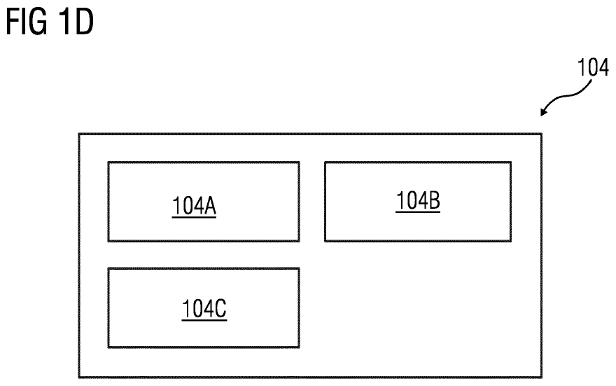

FIG. 1A is a schematic representation of an autonomous vehicle data searching and auditing system (AVDSAS) 100, according to an embodiment of the present disclosure. The AVDSAS 100 is downloadable on a user device (not shown) accessible by a user 106. The AVDSAS 100 is configurable as a web-based platform accessible by the user 106 via a communication network 109. The AVDSAS 100 is configurable to be deployed in a cloud computing environment. The AVDSAS 100 is physically connectable to an adaptive traffic controller system and/or directly to a traffic signal (not shown). The AVDSAS 100 is deployable as an edge device installable at and connectable to the traffic signal for dynamically generating traffic signal plans that the traffic signal executes for smooth flow of traffic at a junction, for example, in a smart campus or a closed premise wherein multiple autonomous vehicles (AVs) ply on the roads of the smart campus.

As shown in FIG. 1A, the AVDSAS 100 comprises a data acquisition module 101, a scenario extraction module 102, an operational design domain (ODD) module 103, an audit module 104, and a graphical user interface (GUI) 105, operably communicating therebetween. The data acquisition module 101 obtains data from one or more sensors (not shown) typically mounted on an autonomous vehicle (AV), for example, a data collection vehicle. The sensors comprise, for example, one or more cameras mountable on the AV for recording images and/or videos of the surroundings thereof, laser-based sensors such as LiDARs and LADARs, radio-based sensors such as RADARs, Inertial Measurement Unit (IMU) sensors, ambient condition monitoring sensors sensing temperature, humidity, pressure, particulate matter, etc., surrounding the AV. The data acquisition module 101 may store the AV data received from the sensors into one or more databases such as a scenario database 108 in the cloud computing environment accessible by the AVDSAS 100 via the communication network 109. Alternatively, the data acquisition module 101 may obtain the AV data from one or more databases such as the scenario database 108 into which the AV data is stored by one or more external sources collecting AV data from the AVs and storing into the one or more databases.

The AVDSAS 100 also comprises a query parsing and analysis module 107 in operable communication with the GUI 105 and the scenario extraction module 102. When the user 106 enters a query via the GUI 105, the query parsing and analysis module 107 parses the query entered and routes the query to the scenario extraction module 102 which in turn may extract the scenarios and/or audit reports in communication with the audit module 104 based on the query.

FIG. 1B is a schematic representation of a scenario extraction module 102 of the AVDSAS 100 shown in FIG. 1A, according to an embodiment of the present disclosure. The scenario extraction module 102 is in an operable communication with the data acquisition module 101 for receiving the AV data. The scenario extraction module 102 comprises a data pre-processing module 102A, a data extraction module 102B, a data storage module 102C and a scenario visualization module 102D. The data pre-processing module 102A receives the AV data from the data acquisition module 101 and verifies whether the AV data is available in an automotive industry standard format, for example, ROSBag format or a measurement data format (MDF). If the AV data is not available in the automotive industry standard format, then the data pre-processing module 102A generates an error notification and renders the error notification onto the GUI 105 of the AVDSAS 100. Alternatively, the data pre-processing module 102A converts the AV data into one of the automotive industry standard formats for further processing.

The data extraction module 102B extracts the metadata from the AV data. For example, the metadata comprises size of the AV data file such as the size of the ROSBag, a start time and/or an end time of the trip made by the AV to which the AV data corresponds, etc. The data storage module 102C stores the extracted metadata into the scenario database 108 shown in FIG. 1A with which the scenario extraction module 102 is in communication with via the communication network 109 shown in FIG. 1A.

The data extraction module 102B determines one or more AV parameters from the AV data. The AV parameters comprise, for example, acceleration, yaw, velocity and/or Global Positioning System (GPS) data of the AV. The data storage module 102C stores the AV parameters in the scenario database 108 corresponding to the AV for which the AV data has been used. The data storage module 102C stores the AV parameters in appropriate databases within the scenario database 108, for example, the raw sensor data from the IMU sensors is stored in the time series database like InfluxDB and the GPS data is stored in PostGIS database. The AV parameters are stored in one of the automotive industry standard formats. The AV parameters can also be queried by a user 106 of the AVDSAS 100.

The data extraction module 102B extracts objects from the AV data. For extracting objects, the data extraction module 102B checks whether the AV data comprises image frames. If not, then the data extraction module 102B generates an error notification and renders it to the user 106 of the AVDSAS 100 via the GUI 105. If yes, the data extraction module 102B extracts the image frames at a predefined time interval, for example, per second. The data extraction module 102B determines object(s) from each of the image frames by applying one or more object detection algorithms on the image frames thus extracted. The object(s) comprise, for example, a vehicle, a pedestrian, a tree, a pavement, etc. The data extraction module 102B enables the users 106 of the AVDSAS 100 to upload their own object annotation and detection algorithms based on the type of AV data being handled. A person skilled in the conventional art may appreciate that the object annotation and detection algorithms are aimed at perceiving objects from the AV data. The data storage module 102C stores the objects in the scenario database 108, for example, in Json format. The data storage module 102C stores the AV parameters and the objects obtained from the AV data at a predefined time precision level such as every second.

The AVDSAS 100 enables its users 106 to run queries via the GUI 105 on the data stored in the scenario database 108 to determine and visualize various scenarios comprising various objects. For example, a user may query the AVDSAS 100 to visualize a scenario where the weather is clear, that is, having good visibility and an AV plying at a velocity of fifteen kilometers per second is taking a right turn at a junction. The query parsing and analysis module 107 of the AVDSAS 100 parses the query to determine the query parameters and provides the query parameters to the scenario extraction module 102 of the AVDSAS 100 which in turn extracts a scenario of choice of the user 106 from the scenario database 108. The scenario visualization module 102D of the scenario extraction module 102 constructs a scenario based on the query parameters using the AV parameters, the objects and the AV data stored in the scenario database 108. For example, a resultant scenario is constructed and rendered on the GUI 105 by the scenario visualization module 102D via one or more visualization tools such as Webviz. The scenario visualization module 102D provides the scenario from the time at which the queried event happened and modifies the resultant scenario to show domain specific attributes, for example, bounding boxes on the objects identified, different attributes of the identified object like Time to Collision (TTC) of the object, velocity of the object, lateral distance of the object from the ego vehicle, etc., to help the user 106 visualize the scenario accurately.

FIG. 1C is a schematic representation of an operational design domain (ODD) module 103 of the AVDSAS 100 shown in FIG. 1A, according to an embodiment of the present disclosure. The ODD module 103 is in an operable communication with data acquisition module 101 of the AVDSAS 100. The ODD module 103 comprises an ODD extraction module 103A, an ODD validation module 103B and an ODD storage module 103C.

The ODD extraction module 103A receives the AV data from the data acquisition module 101 and verifies whether the AV data is in an automotove industry standard format such as ROSbag of MDF formats. The ODD extraction module 103A then extracts one or more ODD elements from the AV data using one or more ODD extraction algorithms, for example, weather identification algorithm, intersection identification algorithm, roundabout identification algorithm, etc. The ODD elements comprise, for example, a weather condition such as rainy weather, snowy weather, clear weather, etc., one or more road features such as potholes, speed bumps, curves, inclining slope, declining slope, etc., a time of the day, etc. The ODD elements may also comprise derived ODD elements such as a geographic zone in which the AV has traveled that may be derived from the AV data. The ODD elements primarily define various operating conditions under which an automated driving system of an AV is designed to function.

The ODD storage module 103C converts the ODD elements into preformulated ODD schematics and stores the ODD elements into an ODD database 103D of the ODD module 103. The preformulated ODD schematics include, for example, ODD elements in a data format suitable for being stored into the ODD databse 103 such as key value pairs of data. Alternatively, the ODD elements are stored in the scenario database 108 of the AVDSAS 100. A user 106 of the AVDSAS 100 may query the data stored in the ODD database 103D by running various queries via the GUI 105, for example, weather_type=rain and intersection=3-way and zones-school. Upon receiving such a query, the query parsing and analysis module 107 of the AVDSAS 100 parses the query to determine the query parameters and routes the query parameters to the ODD module 103. The ODD extraction module 103A extracts all the ODD elements stored in the ODD database 103D that correspond to the weather type, the intersection type i.e, the road type, and the zone i.e, the geographic zone type specified in the user query.

After storing preliminary ODD elements into the ODD database 103D, the ODD validation module 103B can validate every ODD element being extracted and stored into the ODD database 103D using the existing ODD elements in the ODD database 103D. The ODD module 103 in turn may provide an input to the scenario extraction module 102 for increasing precision of constructing scenarios. For example, the ODD elements help in defining the algorithms that can be employed to extract the scenarios as per the defined ODD.

FIG. 1D is a schematic representation of an audit module 104 of the AVDSAS 100 shown in FIG. 1A, according to an embodiment of the present disclosure. The audit module 104 comprises a safety indication module 104A, a performance management module 104B and a critical scenario extraction module 104C. The audit module 104 is in an operable communication with the scenario database 108 via the communication network 109. The audit module 104 is also in operable communication with the data acquisition module 101. The audit module 104 receives the AV data from the data acquisition module 101 and the local legal laws specific to the geography in which the AV has made the trip, for example National Highway Traffic Safety Administration (NHTSA) in the USA. The audit module 104 flags every safe/unsafe scenario in a given trip made by the AV for safety based on the safety definition provided by standards like IEEE 2846. SOTIF, etc.

The safety indication module 104A is configured with one or more algorithms that identify whether a scenario is safe or unsafe using Responsibility-Sensitive Safety (RSS) principles, for example, collision avoidance without causing another collision, adherence to safe lateral cut-in distance during driving, adherence to giving the right of the way, adherence to speed limit when in low visibility areas, etc. The safety indication module 104A accesses scenarios pertaining to the AV data from the scenario database 108 that the scenario extraction module 102 has stored. The safety indication module 104A then runs the RSS based algorithms on each of the stored and/or constructed scenarios to identify whether they are safe or unsafe. The safety indication module 104A stores these scenarios with their attributes into the scenario database 108. The attributes include, for example, a speed of the ego vehicle, maneuvers of the ego vehicle, lateral distance of the ego vehicle from another vehicle in the scenario, etc. Based on these attributes, the RSS based algorithms can decide whether the scenario is safe or unsafe. It would be appreciated by a person skilled in the conventional art that the RSS based algorithms are only an example of determining safe/unsafe scenarios. Other such algorithms can also be used for the determination.

The performance management module 104B uses the safe and unsafe scenarios stored in the scenario database 108 to develop a rating system for the AVs in a fleet of AVs based on their conformance to safety. For example, for a fleet of AVs, based on an average number of unsafe scenarios encountered by each of the AVs in the fleet over a predefined time duration such as per day or per trip, an overall performance rating can be assigned to the individual AVs and/or to the fleet of AVs. The performance management module 104B, based on the safe/unsafe scenarios encountered by an AV, supports various queries that a user 106 of the AVDSAS 100 may run via the GUI 105, for example to know temporal and/or spatial performance reports of the AVs or the fleet of AVs in near real time and/or for historical trips taken by the AVs.

The critical scenario extraction module 104C analyses the unsafe scenarios and extracts the metadata of such unsafe scenarios to create a critical scenario database (not shown) within the scenario database 108. This critical scenario database can then be used for verification and validation of the Automated Driving Systems (ADS) via which the AVs navigate during a trip.

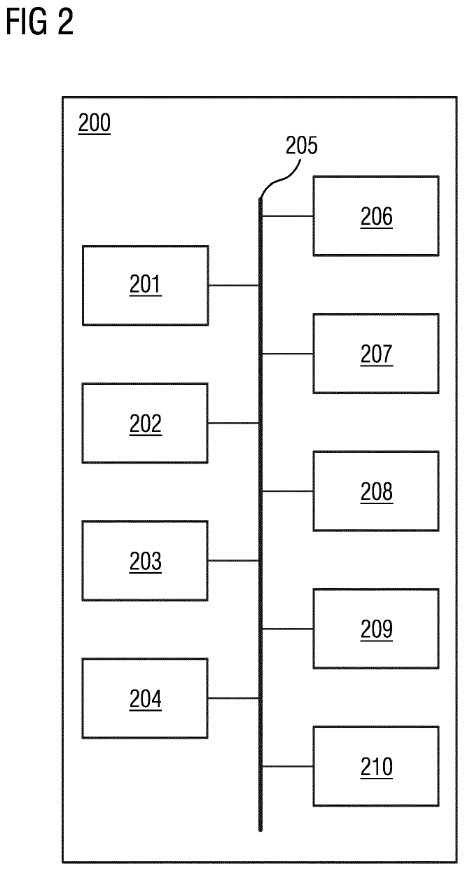

FIG. 2 is a block diagram illustrating an architecture of a computer system 200 employed by the AVDSAS 100 shown in FIG. 1A, according to an embodiment of the present disclosure. The AVDSAS 100 employs the architecture of the computer system 200. The computer system 200 is programmable using a high-level computer programming language. The computer system 200 may be implemented using programmed and purposeful hardware. The computer system 200 comprises a processor 201, a non-transitory computer readable storage medium such as a memory unit 202 for storing programs and data, an input/output (I/O) controller 203, a network interface 204, a data bus 205, a display unit 206, input devices 207, a fixed media drive 208 such as a hard drive, a removable media drive 209 for receiving removable media, output devices 210, etc. The processor 201 refers to any one of microprocessors, central processing unit (CPU) devices, finite state machines, microcontrollers, digital signal processors, an application specific integrated circuit (ASIC), a field-programmable gate array (FPGA), etc., or any combination thereof, capable of executing computer programs or a series of commands, instructions, or state transitions. The processor 201 may also be implemented as a processor set comprising, for example, a general-purpose microprocessor and a math or graphics co-processor. The AVDSAS 100 disclosed herein is not limited to a computer system 200 employing a processor 201. The computer system 200 may also employ a controller or a microcontroller. The processor 201 executes the modules, for example, 101, 102, 103, 104, 107, etc., of the AVDSAS 100.

The memory unit 202 is used for storing programs, applications, and data. For example, the modules 101, 102, 103, 104, 107, etc., of the AVDSAS 100 are stored in the memory unit 202 of the computer system 200. The memory unit 202 is, for example, a random-access memory (RAM) or another type of dynamic storage device that stores information and instructions for execution by the processor 201. The memory unit 202 also stores temporary variables and other intermediate information used during execution of the instructions by the processor 201. The computer system 200 further comprises a read only memory (ROM) or another type of static storage device that stores static information and instructions for the processor 201. The I/O controller 203 controls input actions and output actions performed by the AVDSAS 100.

The network interface 204 enables connection of the computer system 200 to the communication network 109. For example, the AVDSAS 100 connects to the communication network 109 via the network interface 204. In an embodiment, the network interface 204 is provided as an interface card also referred to as a line card. The network interface 204 comprises, for example, interfaces using serial protocols, interfaces using parallel protocols, and Ethernet communication interfaces, interfaces based on wireless communications technology such as satellite technology, radio frequency (RF) technology, near field communication, etc. The data bus 205 permits communications between the modules, for example, 101, 102, 103, 104, 105, 107, 108, etc., of AVDSAS 100.

The display unit 206, via the graphical user interface (GUI) 105, displays information such as the safe and unsafe scenarios that the audit module 104 has identified and/or the reports generated by the audit module 104 based on performance of the autonomous vehicle (AV) in one or more trips. The display unit 206, via the GUI 105, also displays information such as user interface elements including text fields, buttons, windows, etc., for allowing a user to provide his/her inputs such as criteria to visualize the performance of the AV, his/her queries for searching through the scenarios stored in the scenario database 108 or the ODD database 103D etc. The display unit 206 comprises, for example, a liquid crystal display, a plasma display, an organic light emitting diode (OLED) based display, etc. The input devices 207 are used for inputting data into the computer system 200. The input devices 207 are, for example, a keyboard such as an alphanumeric keyboard, a touch sensitive display device, and/or any device capable of sensing a tactile input.

Computer applications and programs are used for operating the computer system 200. The programs are loaded onto the fixed media drive 208 and into the memory unit 202 of the computer system 200 via the removable media drive 209. In an embodiment, the computer applications and programs may be loaded directly via the communication network 109. Computer applications and programs are executed by double clicking a related icon displayed on the display unit 206 using one of the input devices 207. The output devices 210 output the results of operations performed by the AVDSAS 100. For example, the AVDSAS 100 provides a graphical representation of the AV performance, using the output devices 210.

The processor 201 executes an operating system. The computer system 200 employs the operating system for performing multiple tasks. The operating system is responsible for management and coordination of activities and sharing of resources of the computer system 200. The operating system further manages security of the computer system 200, peripheral devices connected to the computer system 200, and network connections. The operating system employed on the computer system 200 recognizes, for example, inputs provided by the users using one of the input devices 207, the output display, files, and directories stored locally on the fixed media drive 208. The operating system on the computer system 200 executes different programs using the processor 201. The processor 201 and the operating system together define a computer platform for which application programs in high level programming languages are written.

The processor 201 of the computer system 200 employed by the AVDSAS 100 retrieves instructions defined by the modules 101, 102, 103, 104, 107, etc., of the AVDSAS 100 for performing respective functions disclosed in the detailed description of FIGS. 1A-ID. The processor 201 retrieves instructions for executing the modules, for example, 101, 102, 103, 104, 107, etc., of the AVDSAS 100 from the memory unit 202. A program counter determines the location of the instructions in the memory unit 202. The program counter stores a number that identifies the current position in the program of each of the modules, for example, 101, 102, 103, 104, 107, etc., of the AVDSAS 100. The instructions fetched by the processor 201 from the memory unit 202 after being processed are decoded. The instructions are stored in an instruction register in the processor 201. After processing and decoding, the processor 201 executes the instructions thereby, performing one or more processes defined by those instructions.

At the time of execution, the instructions stored in the instruction register are examined to determine the operations to be performed. The processor 201 then performs the specified operations. The operations comprise arithmetic operations and logic operations. The operating system performs multiple routines for performing several tasks required to assign the input devices 207, the output devices 210, and memory for execution of the modules, for example, 101, 102, 103, 104, 107, etc., of the AVDSAS 100. The tasks performed by the operating system comprise, for example, assigning memory to the modules, for example, 101, 102, 103, 104, 107, etc., of the AVDSAS 100, and to data used by the AVDSAS 100, moving data between the memory unit 202 and disk units, and handling input/output operations. The operating system performs the tasks on request by the operations and after performing the tasks, the operating system transfers the execution control back to the processor 201. The processor 201 continues the execution to obtain one or more outputs. The outputs of the execution of the modules, for example, 101, 102, 103, 104, 107, etc., of the AVDSAS 100 are displayed to the user on the GUI 105.

For purposes of illustration, the detailed description refers to the AVDSAS 100 being run locally on the computer system 200, however the scope of embodiments of the present invention is not limited to the AVDSAS 100 being run locally on the computer system 200 via the operating system and the processor 201, but may be extended to run remotely over the communication network 109 by employing a web browser and a remote server, a mobile phone, or other electronic devices. One or more portions of the computer system 200 may be distributed across one or more computer systems (not shown) coupled to the communication network 109.

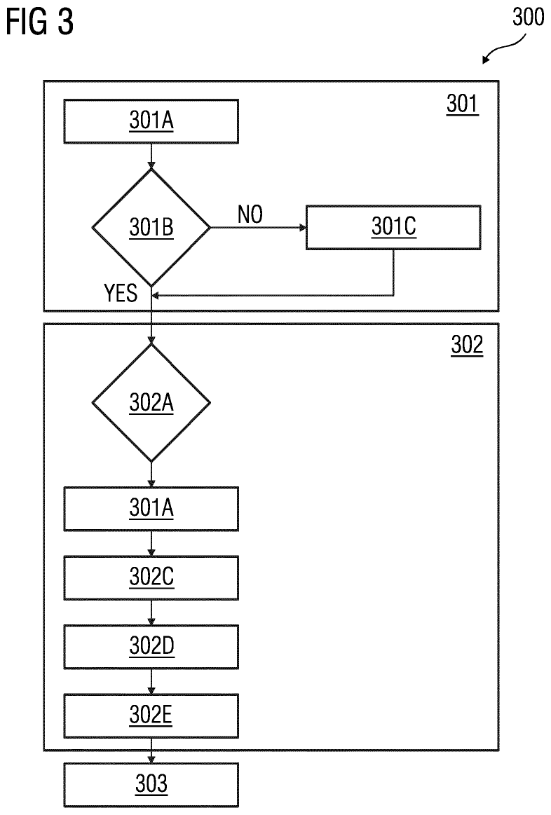

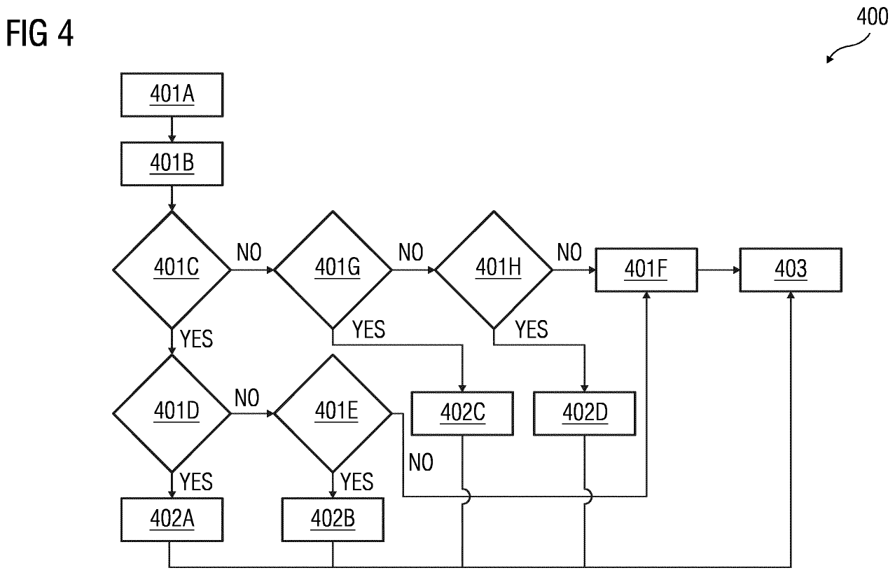

Disclosed herein is also a computer program product comprising a non-transitory computer readable storage medium that stores computer program codes comprising instructions executable by at least one processor 201 for managing AV data and for searching and auditing the AV data as disclosed in the detailed descriptions of FIG. 3 and FIG. 4.

The computer program codes comprising computer executable instructions are embodied on the non-transitory computer readable storage medium. The processor 201 of the computer system 200 retrieves these computer executable instructions and executes them. When the computer executable instructions are executed by the processor 201, the computer executable instructions cause the processor 201 to perform the steps of the methods for managing AV data and for searching and auditing the AV data.

FIG. 3 is a process flowchart representing a method 300 for managing autonomous vehicle (AV) data, according to an embodiment of present disclosure. In embodiments, the method 300 shown in FIG. 3 employs the autonomous vehicle data searching and auditing system (AVDSAS) 100 shown in FIG. 1A. In embodiments, the method 300 includes following process flow steps:

In embodiments, the method 300 at step 301 obtains AV data from sensor(s) mountable on AV(s). At step 301A, the data acquisition module 101 of the AVDSAS 100 receives the AV data from the sensors. Alternatively, at step 301A, the data acquisition module 101 receives the AV data from external source(s) such as a cloud based database in which the AV data is stored. At step 301B, the data pre-processing module 102A of the scenario extraction module 102 of the AVDSAS 100 verifies whether the AV data is in an automotive industry standard format. If not, then at step 301C the data acquisition module 101 converts the AV data into an automotive industry standard format such as ROSbag or MDF.

In embodiments, the method 300 at step 302 extracts, from the AV data, scenario data associated with the AV(s). The scenario data comprises AV parameters and objects. The scenario data may also comprise operational design domain (ODD) elements associated with the AV(s). At step 302A, the scenario extraction module 102 checks with the user 106 of the AVDSAS 100 whether he/she would like to upload any algorithms of his/her choice, for example, data annotation algorithms. If yes, then at step 302B, the scenario extraction module 102 receives the algorithms from the user 106 and provides these algorithms to the data extraction module 102B. At step 302C, the data extraction module 102B obtains the AV parameters from the AV data. The AV parameters comprise an acceleration, a yaw, a velocity, and/or global positioning system coordinates of an AV with which the AV data is associated. At step 302D, the data extraction module 102B obtains from the AV data, object(s) associated with the AV. The object(s) comprise stationary and moving objects in proximity of the AV such as a tree, another AV, a pavement, etc. At step 302E, the ODD module 103 of the AVDSAS 100 obtains from the AV data, ODD element(s) comprising constraints associated with a domain in which the AV is configured to operate such as road conditions, weather conditions, etc.

In embodiments, the method 300 at step 303 stores the scenario data, that is, the AV parameters, the objects, and/or the ODD elements into a scenario database 108. It would be appreciated by a person skilled in the conventional art that the scenario database 108 need not be a single database but may comprise several smaller databases storing data categorically therein. The scenario data that the AVDSAS 100 stores in the scenario database 108, is indexed, for example, as time series data, GPS data, etc. prior to its storage into the scenario database 108 for ease of data retrieval.

FIG. 4 is a process flowchart representing a method 400 for searching and analyzing autonomous vehicle (AV) data, according to an embodiment of the present disclosure. In embodiments, the method 400 shown in FIG. 4 employs the autonomous vehicle data searching and auditing system (AVDSAS) 100 shown in FIG. 1A. In embodiments, the method 400 includes following process flow steps:

In embodiments, the method 400 at step 401, obtains query parameters from a query for searching and analyzing the AV data. At step 401A, the query parsing and analysis module 107 of the AVDSAS 100 receives the query entered by a user 106 of the AVDSAS 100 via the GUI 105. At step 401B, the query parsing and analysis module 107 obtains query parameters associated with the query, for example a query type and a query criterion/criteria. The query type includes a search-based query, an audit-based query and/or a report-based query. Similarly, the query criteria include specific parameters associated with the query type such as scenario search, ODD elements search, audit safe scenario, audit unsafe scenario, audit critical scenario, fleet-based performance report, etc. The query criteria may also include specific parameters such as rainy weather, slippery terrain, steep incline, accident prone zone, etc. At step 401C, the query parsing and analysis module 107 checks whether the query type is search, if yes, then at step 401D the query parsing and analysis module 107 checks whether the query criterion is scenario based search, if yes, then at step 402A the scenario extraction module 102 extracts the scenario data from the scenario database 108 as per the specific query parameters and constructs a scenario for visualization, for example, by applying bounding boxes around the objects in the scenario. At step 401D if the query criterion is not scenario-based search, then the query parsing and analysis module 107 at step 401E checks whether the query criterion is ODD elements-based search. If yes, then at step 402B the ODD module 103 extracts the ODD elements from the scenario database 108 or from the ODD database 103D shown in FIG. 1C, the ODD elements corresponding to the query criteria. At step 401E, if the query criterion is not for ODD elements-based search, then at step 401F, the query parsing and analysis module 107 generates an error notification for the user 106.

At step 401C, if the query type is not search, then at step 401G, the query parsing and analysis module 107 checks whether the query type is an audit-based query. If yes, then at step 402C the audit module 104 determines from the scenarios generated and stored in the scenario database 108 by the scenario extraction module 102, a safe scenario, an unsafe scenario, and/or a critical scenario, based on the query parameters and predefined audit parameters such as local legal laws of a geographical area in which the user 106 is located. At step 401G, if the query type is not an audit-based query, then at step 401H, the query parsing and analysis module 107 checks whether the query type is a report-based query. If yes, then at step 402D, the audit module 104 generates performance reports based on the query parameters, for example, performance of a fleet of AVs for the specified time duration. If not, then the method 400 goes to step 401F.

At step 403, the AVDSAS 100 renders, for example, via the GUI 105, scenario(s), ODD element(s), performance reports, etc., generated by the modules 102-104 of the AVDSAS 100 based on the query parameters.

Where databases are described such as the scenario database 108 or the ODD database 103D, it will be understood by one of ordinary skill in the conventional art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only: one of ordinary skill in the conventional art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present disclosure can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present disclosure is not limited to a particular computer system platform, processor, operating system, or network. One or more aspects of the present disclosure may be distributed among one or more computer systems, for example, servers configured to provide one or more services to one or more client computers, or to perform a complete task in a distributed system. For example, one or more aspects of the present disclosure may be performed on a client-server system that comprises components distributed among one or more server systems that perform multiple functions according to various embodiments. These components comprise, for example, executable, intermediate, or interpreted code, which communicate over a network using a communication protocol. The present disclosure is not limited to be executable on any particular system or group of systems, and is not limited to any particular distributed architecture, network, or communication protocol.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An autonomous vehicle data searching and auditing system comprising and wherein:
a scenario database configured to store therein autonomous vehicle data associated with one or more autonomous vehicles, wherein the autonomous vehicle data stored in the scenario database is searchable based on a query; and
a scenario extraction module in operable communication with the scenario database, configured to perform one or more of:
extract scenario data from the autonomous vehicle data and store the scenario data into the scenario database, wherein the scenario data comprises one or more autonomous vehicle parameters and one or more objects associated with the one or more autonomous vehicles; and
generate one or more scenarios using the scenario data from the scenario database based on the query.

2. The autonomous vehicle data searching and auditing system according to claim 1, comprising a data acquisition module configured to obtain the autonomous vehicle data from one or more sensors mountable on the one or more autonomous vehicles.

3. The autonomous vehicle data searching and auditing system according to claim 1, wherein the scenario extraction module comprises a data pre-processing module configured to perform one or more of:
verify whether the autonomous vehicle data is in an automotive industry standard format; and
convert the autonomous vehicle data into an automotive industry standard format when the autonomous vehicle data is not in the automotive industry standard format.

4. The autonomous vehicle data searching and auditing system according to claim 1, wherein the scenario extraction module comprises a data extraction module configured to perform one or more of:
obtain, from the autonomous vehicle data, one or more autonomous vehicle parameters associated with an autonomous vehicle, wherein the autonomous vehicle parameters comprise one or more of an acceleration, a yaw, a velocity, and global positioning system coordinates of the autonomous vehicle; and
obtain, from the autonomous vehicle data, one or more objects associated with an autonomous vehicle, wherein the one or more objects comprise stationary and moving objects in proximity of the autonomous vehicle.

5. The autonomous vehicle data searching and auditing system according to claim 4, wherein the scenario extraction module comprises a data storage module configured to store the autonomous vehicle data, the autonomous vehicle parameters, and the objects into the scenario database.

6. The autonomous vehicle data searching and auditing system according to claim 4, wherein the scenario extraction module comprises a scenario visualization module configured to generate, based on the query, a scenario using the autonomous vehicle parameters, the objects, and the autonomous vehicle data stored in the scenario database.

7. The autonomous vehicle data searching and auditing system according to claim 1, further comprising an operational design domain module configured to perform one or more of:
obtain one or more operation design domain elements from the autonomous vehicle data and store the operation design domain elements into the scenario database, wherein the operational design domain elements comprise constraints associated with a domain in which the autonomous vehicle is configured to operate; and
obtain one or more operational design domain elements from the scenario database based on the query.

8. The autonomous vehicle data searching and auditing system according to claim 1, wherein the scenario extraction module comprises an audit module configured to determine from the scenario database, one or more of a safe scenario, an unsafe scenario, and a critical scenario, based on predefined audit parameters and the query.

9. A method for managing autonomous vehicle data, the method employing the autonomous vehicle data searching and auditing system according to claim 1 and wherein:
obtaining autonomous vehicle data from one or more sensors mountable on one or more autonomous vehicles;
extracting, from the autonomous vehicle data, scenario data associated with the one or more autonomous vehicles, wherein the scenario data comprises one or more autonomous vehicle parameters and one or more objects associated with the one or more autonomous vehicles; and
storing the scenario data into a scenario database.

10. The method according to claim 9, further comprising:
verifying whether the autonomous vehicle data is in an automotive industry standard format; and
converting the autonomous vehicle data into an automotive industry standard format when the autonomous vehicle data is not in the automotive industry standard format.

11. The method according to claim 9, wherein extracting the scenario data comprises:
obtaining, from the autonomous vehicle data, one or more autonomous vehicle parameters, wherein the autonomous vehicle parameters comprise one or more of an acceleration, a yaw, a velocity, and global positioning system coordinates of the autonomous vehicle; and
obtaining, from the autonomous vehicle data, one or more objects associated with the autonomous vehicle, wherein the one or more objects comprise stationary and moving objects in proximity of the autonomous vehicle.

12. The method according to claim 9, further comprising obtaining one or more operation design domain elements from the autonomous vehicle data, wherein the operational design domain elements comprise constraints associated with a domain in which the autonomous vehicle is configured to operate.

13. A method for searching and auditing autonomous vehicle data, the method employing the autonomous vehicle data searching and auditing system according to claim 1 and wherein:
obtaining query parameters from a query for searching and auditing the autonomous vehicle data;
generating one or more scenarios based on the query parameters; and
rendering the one or more scenarios on a graphical user interface of the autonomous vehicle data searching and auditing system.

14. The method according to claim 13, wherein generating one or more scenarios comprises constructing, based on the query parameters of the query, a scenario using the autonomous vehicle parameters, the objects, and the autonomous vehicle data stored in the scenario database.

15. The method according to claim 13, further comprising:
obtaining one or more operational design domain elements from the scenario database based on the query parameters and rendering the operational design domain elements on the graphical user interface of the autonomous vehicle data searching and auditing system; and
determining from the scenario database one or more of a safe scenario, an unsafe scenario, and a critical scenario, based on the query parameters and predefined audit parameters and rendering one or more of the safe scenario, the unsafe scenario, and the critical scenario on the graphical user interface of the autonomous vehicle data searching and auditing system.
